(19) United States
(12) Patent Application Publication
(10) Pub. No.: US 2026/0283903 A1
(43) Pub. Date: Sep. 24, 2026

(54) Medicament bag assembly

(71) Applicant: SHL Medical AG, Zug (CH)

(72) Inventors: Christoph Egloff, Zug (CH); Lukas Bannwart, Zug (CH); Núria De Santiago Giner, Zug (CH); Samuel Wyler, Zug (CH); Christopher James Franzese, Boonton, NJ (US); Matthew Conner D'Auria, Boonton, NJ (US); Katherine Ford Brigham, Boonton, NJ (US)

(21) Appl. No.: 19/473,838

(22) PCT Filed: Apr. 3, 2024
(86) PCT No.: PCT/EP2024/059049

§ 371 Date: Oct. 9, 2025

Related U.S. Application Data
(60) Provisional application No. 63/459,733, filed on Apr. 17, 2023.

(30) Foreign Application Priority Data
Oct. 24, 2023 (EP) 23205408.0

(51) Int. Cl. A61J 1/10; A61J 1/14

(52) U.S. Cl. CPC A61J 1/10; A61J 1/1475; A61J 1/1493

(57) ABSTRACT

The present disclosure relates to a bag assembly for a medicament delivery device. The bag assembly comprises a medicament bag configured to receive a fluid medicament, a port in fluid connection with an interior of the medicament bag and configured to allow the fluid medicament to enter and exit the medicament bag and a frame surrounding the medicament bag. The frame is at least in partial connection with the medicament bag and configured to support the medicament bag in a first axis direction and/or second axis direction.

### TECHNICAL FIELD

The present disclosure relates to a bag assembly for a medicament delivery device.

### BACKGROUND

Flexible medicament bags containing a liquid drug are used in various manually or automatically operated medicament delivery devices. However, the flexible nature of the medicament bag may in some cases lead to a collapse or deformation of the medicament bag during filling or during medicament delivery and thus hinder completely filling or emptying the medicament bag. This is of particular importance for higher volume bags.

With higher volumes, bending and kinking during or after the filling procedure starts with lower pressure inside the bag. Bending and kinking not only affect the filling and emptying completeness, but also might hinder the film barrier property, the seal seam integrity or might by identified as a quality issue. One way is to increase the footprint to remain the internal pressure low which is not beneficial for the overall device size.

The present disclosure provides solutions to the above-mentioned problems. In particular, the present disclosure provides a frame supporting the medicament bag.

### SUMMARY

The invention is specified by the independent claim. Preferred embodiments are defined in the dependent claims.

The present disclosure relates to a bag assembly for a medicament delivery device. The bag assembly comprises a medicament bag configured to receive a fluid medicament, a port in fluid connection with an interior of the medicament bag and configured to allow the fluid medicament to enter and exit the medicament bag and a frame surrounding the medicament bag. The frame is at least in partial connection with the medicament bag and configured to support the medicament bag in a first axis direction and/or second axis direction. The medicament bag comprises at least one fastening member and the frame comprises at least one corresponding receiving member configured to engage with the fastening member.

Various embodiments may preferably implement the following features.

Preferably, the frame is at least in partial connection with the medicament bag at an outer circumference of the medicament bag in the first and/or second axis direction.

Preferably, the fastening member is a form fit feature, more preferably a slit or a hole, provided at an outer circumference of the medicament bag.

Preferably, the receiving member is a knob-shaped member, a hook, or a pin.

Preferably, the frame comprises a first frame part and a second frame part.

Preferably, the receiving member is formed as complementary shapes on the first frame part and the second frame part.

Preferably, the receiving member protrudes from the frame in a direction perpendicular to the first axis direction and the second axis direction.

Preferably, the frame is connected to the port.

Preferably, the frame is integrally formed with the port.

Preferably, a film is configured to enclose the medicament bag and a least a portion of the port.

Preferably, the film is closed by welding, in particular ultrasonic welding, or gluing.

Preferably, the film is attached to both sides of the frame.

Preferably, the at least one fastening member is provided in a welding seam of the film and/or the medicament bag.

Preferably, the first axis direction is a lateral direction and the second axis direction is a longitudinal direction.

Preferably, the longitudinal direction (second axis direction) is a direction of the fluid medicament exiting the port and the lateral direction (first axis direction) is perpendicular to the longitudinal direction. A height direction (third axis direction) is perpendicular to both the first and the second axis direction.

As outlined above, the terms “longitudinal”, “longitudinally”, “axially” and “axial” refer to a direction extending through the outlet port or in the direction of the fluid medicament exiting the outlet port. It is also referred to as a second axis direction or y-axis direction.

Similarly, the terms “lateral”, “laterally”, “transverse”, “transversal” and “transversally” refer to a direction generally perpendicular to the longitudinal direction. It is also referred to as a first axis direction or x-axis direction.

A third axis direction or z-axis direction may be referred to as a height direction and is perpendicular to both the first and the second axis direction.

Further, the terms “circumference”, “circumferential”, or “circumferentially” refer to a circumference or a circumferential direction relative to an axis, typically a central axis extending in the direction of the longest extension of the device and/or component. Similarly, “radial” or “radially” refer to a direction extending radially relative to the axis, and “rotation”, “rotational” and “rotationally” refer to rotation relative to the axis.

Generally, all terms used in the claims are to be interpreted according to their ordinary meaning in the technical field, unless explicitly defined otherwise herein. All references to a/an/the element, apparatus, member, component, means, etc. are to be interpreted openly as referring to at least one instance of the element, apparatus, member component, means, etc., unless explicitly stated otherwise.

### BRIEF DESCRIPTION OF THE DRAWINGS

Embodiments of the present disclosure will now be described by way of example only and with reference to the following accompanying drawings.

FIG. 1 shows a bag assembly according to an embodiment of the present disclosure.

FIG. 2 shows a frame according to an embodiment of the present disclosure.

FIG. 3 shows a frame part according to an embodiment of the present disclosure.

FIG. 4 shows a cross-sectional view of a medicament bag according to an embodiment of the present disclosure.

### DETAILED DESCRIPTION

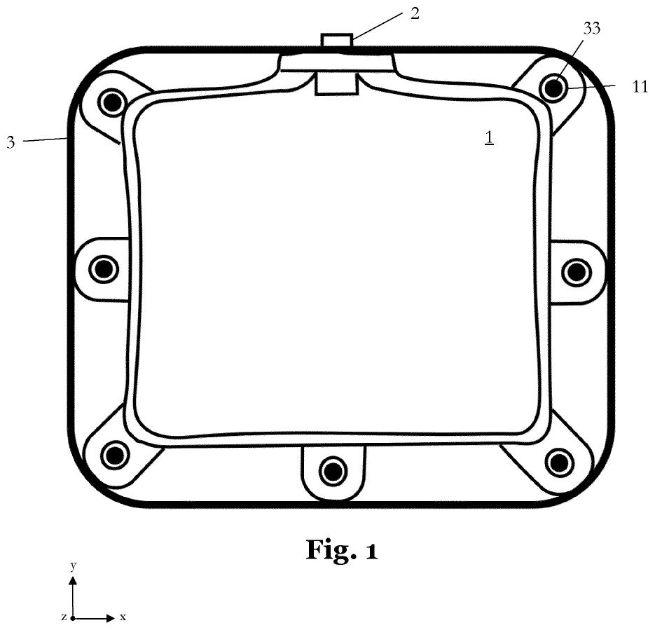

The present disclosure relates to a bag assembly for a medicament delivery device. As visible on FIG. 1, the bag assembly may comprise a medicament bag 1 and a frame 3 surrounding the medicament bag 1.

The bag 1 may be a primary drug container and formed as a flat bag made of plastics. The materials used preferably show excellent barrier properties and allow long storage like glass vials.

The bag assembly may contain at least the medicament bag 1 and a port 2. The port 2 may be in fluid connection with an interior of the medicament bag 1 and configured to allow the fluid medicament to enter and exit the medicament bag 1. The bag assembly may further comprise a (multilayer) film, which is welded to the port 2. The film may also be welded to the medicament bag 1 together with the port 2. It may be provided to contain interfaces and provide access to the drug content and lastly serve as the closure to close the whole system.

The frame 3 is configured to surround the medicament bag 1. In particular, the frame 3 is at least in partial connection with the medicament bag 1 and configured to support the medicament bag 1 in the first axis direction (x-axis direction) and/or second axis direction (y-axis direction). The frame 3 may also be configured to tension the medicament bag 1 by said connection.

The frame 3 may be substantially rectangular. The frame 3 may also be provided in any other shape following the shape of a respective medicament bag 1. For example, the frame 3 and/or the medicament bag 1 may be round. Also, the shapes of the frame 3 and the medicament bag 1 may differ from each other.

In particular, the frame 3 may be at least in partial connection with the medicament bag 1 at an outer circumference of the medicament bag 1 in the first and/or second axis direction.

In order to provide a connection between the medicament bag 1 and the frame 3, the medicament bag 1 may comprise at least one fastening member 11 and the frame 3 may comprise at least one corresponding receiving member 33. The receiving member(s) 33 may be configured to engage with the corresponding fastening member(s) 11.

The fastening member 11 may be a form fit feature, such as a slit or a hole, or any other feature/method such as a clamping (force fit) or gluing/welding connection. In particular, the form fit feature may be provided at an outer circumference of the medicament bag 1, e.g., a welding seam.

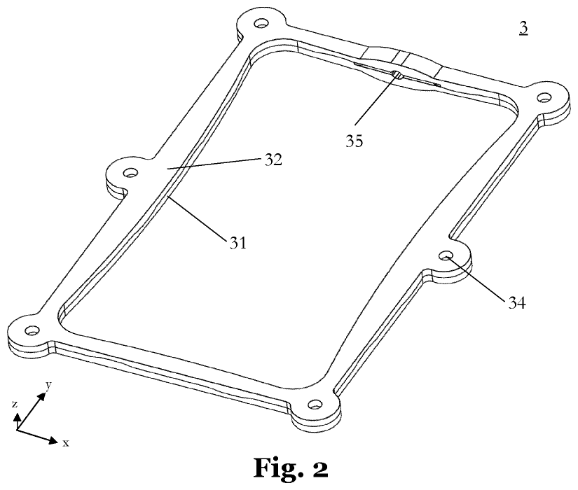

FIG. 2 shows a frame 3 according to an embodiment. The frame 3 may be suitable for various form fit features but will be mainly described referring to slits as fastening members 11.

The frame 3 may comprise a first frame part 31 and a second frame part 32 wherein both frame parts may be substantially similarly shaped, and the terminology is not to be seen as limiting. The medicament bag 1 (not shown) may be provided between the first frame part 31 and the second frame part 32. A port recess 35 may be provided to receive the port 2 of the medicament bag 1 and to allow filling and emptying the medicament bag 1 with a fluid medicament. Moreover, at least one attachment member 34 may be provided at an outer circumference of the frame 3 allowing to fixate the bag assembly to a further element.

The first frame part 31 and the second frame part 32 may be attached to each other by a snap fit, gluing, welding, screwing or the like.

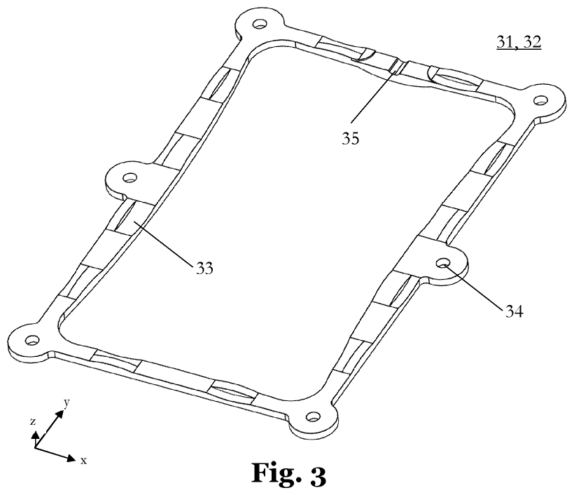

FIG. 3 is a depiction of a disassembled frame 3 and shows one of the first frame part 31 or second frame part 32. In the shown embodiment, there are several receiving members 33. The first frame part 31 and the second frame part 32 may be provided with corresponding or complementary receiving members 33. That is, the first frame part 31 and the second frame part 32 may be provided with corresponding or complementary shapes as receiving members 33. That is, the receiving members 33 of the first frame part 31 and second frame part 32 may be configured to clamp the medicament bag 1 in between. In particular, the slits 11 may be provided at positions corresponding to the receiving members 33. The receiving members 33 may engage the slits 11. That is, the receiving members 33 may push the material of the medicament bag 1 next to the slits 11 in opposite directions. Hence, a form-lock may be created.

The receiving members 33 may, e.g., be formed in a wave shape (as in FIG. 3) or as substantially rectangular recesses and protrusions.

In case holes are provided as the fastening members 11, the receiving members 33 may be formed as a pin on the first frame part 31 and a corresponding hole on the second frame part 32 or vice versa. The pins 33 may thus engage the holes 11 and support the medicament bag 1 at the frame 3.

In general, the receiving members 33 may extend in a third axis direction (height direction, z-axis direction) perpendicular to the first axis direction and the second axis direction. That is, the receiving members 33 may protrude or be recessed in the third axis direction.

Also, with reference to FIG. 1, the fastening members 11 of the medicament bag 1 may be provided as holes 11. In particular, the holes 11 may be provided at an outer circumference of the medicament bag 11. That is, holes 11 may be punched through a (welding) seam or flaps extending outwardly from the medicament bag 1 (x- and y-direction) having the holes 11 may be provided. The frame 3 may comprise corresponding receiving members 33. Said receiving members 33 may be provided as knob-shaped members, hooks or pins. The receiving members 33 may protrude in the third axis direction. The connection between the frame 3 and the medicament bag 1, i.e., between the receiving members 33 and the fastening members 11, may also be created by gluing or welding. As shown in FIG. 3, the engagement of the receiving members 33 with the fastening members 11 may support and/or tension the medicament bag 1.

The frame 3 may be formed as a substantially rectangular bracket. Also, the frame 3 may have any other shape (e.g., according to a desired architecture) independent of a medicament bag's 1 shape.

The frame 3 may be connected to the port 2, e.g., via the port recess 35, or the frame 3 may be integrally formed with the port 2.

A film may be configured to enclose the medicament bag 1 and a least a portion of the port 2 and/or the frame 3. The film may be closed by welding, in particular ultrasonic welding, or gluing. The film may be attached to both sides of the frame 3. That is, the frame 3 may be provided between two film layers thus forming a film-frame-film structure. Such a structure may be beneficial particular in the region of the port 2 in which in other embodiments the film-frame-film weld goes into a film-film weld. Moreover, the gap or distance, respectively between the film created by the interposed frame 3 may be beneficial for filling and emptying the drug.

As outlined above, the at least one fastening member 11 may be provided in a welding seam of the film and/or the medicament bag 1.

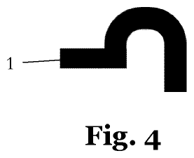

FIG. 4 shows an alternative structure of the medicament bag 1 in which the use of a frame is redundant. Therein, the welding seam includes a 3D shape giving rigidity to the bag and thus preventing bending and kinking. In the embodiment shown in FIG. 4, the welding seam may exhibit a U-shape or hook shape when viewed in a cross-section (x-z-plane or x-y-plane) but the disclosure is not limited thereto.

According to the present disclosure, a bag assembly comprising a frame surrounding a medicament bag with full or partial connection between both elements has been provided. The structure achieves supporting and/or tensioning the medicament bag, thereby preventing unwanted bending or kinking behaviour. Through this support and/or tension, a reliable filling and particular emptying procedure of the medicament bag is ensured. Moreover, barrier property changes in case of long time storage can be prevented.

The medicament bag assembly described herein can be used for medicament devices for the treatment and/or prophylaxis of one or more of many different types of disorders.

Exemplary disorders include, but are not limited to: rheumatoid arthritis, inflammatory bowel diseases (e.g. Crohn's disease and ulcerative colitis), hypercholesterolaemia and/or dyslipidemia, cardiovascular disease, diabetes (e.g. type 1 or 2 diabetes), psoriasis, psoriatic arthritis, spondyloarthritis, hidradenitis suppurativa, Sjögren's syndrome, migraine, cluster headache, multiple sclerosis, neuromyelitis optica spectrum disorder, anaemia, thalassemia, paroxysmal nocturnal hemoglobinuria, hemolytic anaemia, hereditary angioedema, systemic lupus erythematosus, lupus nephritis, myasthenia gravis, Behçet's disease, hemophagocytic lymphohistiocytosis, atopic dermatitis, retinal diseases (e.g., age-related macular degeneration, diabetic macular edema), uveitis, infectious diseases, bone diseases (e.g., osteoporosis, osteopenia), asthma, chronic obstructive pulmonary disease, thyroid eye disease, nasal polyps, transplant, acute hypoglycaemia, obesity, anaphylaxis, allergies, sickle cell disease, Alzheimer's disease, Parkinson's disease, dementia with Lewy bodies, systemic infusion reactions, immunoglobulin E (IgE)-mediated hypersensitivity reactions, cytokine release syndrome, immune deficiencies (e.g., primary immunodeficiency, chronic inflammatory demyelinating polyneuropathy), enzyme deficiencies (e.g., Pompe disease, Fabry disease, Gaucher disease), growth factor deficiencies, hormone deficiencies, coagulation disorders (e.g., hemophilia, von Willebrand disease, Factor V Leiden), and cancer.

Exemplary types of drugs that could be included in the delivery devices described herein include, but are not limited to, small molecules, hormones, cytokines, blood products, enzymes, vaccines, anticoagulants, immunosuppressants, antibodies, antibody-drug conjugates, neutralizing antibodies, reversal agents, radioligand therapies, radioisotopes and/or nuclear medicines, diagnostic agents, bispecific antibodies, proteins, fusion proteins, peptibodies, polypeptides, pegylated proteins, protein fragments, nucleotides, protein analogues, protein variants, protein precursors, protein derivatives, chimeric antigen receptor T cell therapies, cell or gene therapies, oncolytic viruses, or immunotherapies.

Exemplary drugs that could be included in the delivery devices described herein include, but are not limited to, immuno-oncology or bio-oncology medications such as immune checkpoints, cytokines, chemokines, clusters of differentiation, interleukins, integrins, growth factors, coagulation factors, enzymes, enzyme inhibitors, retinoids, steroids, signaling proteins, pro-apoptotic proteins, anti-apoptotic proteins, T-cell receptors, B-cell receptors, or costimulatory proteins.

Exemplary drugs that could be included in the delivery devices described herein include, but are not limited to, those exhibiting a proposed mechanism of action, such as human epidermal growth factor receptor 2 (HER-2) receptor modulators, interleukin (IL) modulators, interferon (IFN) modulators, complement modulators, glucagon-like peptide-1 (GLP-1) modulators, glucose-dependent insulinotropic polypeptide (GIP) modulators, cluster of differentiation 38 (CD38) modulators, cluster of differentiation 22 (CD22) modulators, C1 esterase modulators, bradykinin modulators, C-C chemokine receptor type 4 (CCR4) modulators, vascular endothelial growth factor (VEGF) modulators, B-cell activating factor (BAFF), P-selectin modulators, neonatal Fc receptor (FcRn) modulators, calcitonin gene-related peptide (CGRP) modulators, epidermal growth factor receptor (EGFR) modulators, cluster of differentiation 79B (CD79B) modulators, tumor-associated calcium signal transducer 2 (Trop-2) modulators, cluster of differentiation 52 (CD52) modulators, B-cell maturation antigen (BCMA) modulators, enzyme modulators, platelet-derived growth factor receptor A (PDGFRA) modulators, cluster of differentiation 319 (CD319 or SLAMF7) modulators, programmed cell death protein 1 and programmed death-ligand 1 (PD-1/PD-L1) inhibitors/modulators, B-lymphocyte antigen cluster of differentiation 19 (CD19) inhibitors, B-lymphocyte antigen cluster of differentiation 20 (CD20) modulators, cluster of differentiation 3 (CD3) modulators, cytotoxic T-lymphocyte-associated protein 4 (CTLA-4) inhibitors, T-cell immunoglobulin and mucin-domain containing-3 (TIM-3) modulators, T cell immunoreceptor with Ig and ITIM domains (TIGIT) modulators, V-domain Ig suppressor of T cell activation (VISTA) modulators, indoleamine 2,3-dioxygenase (IDO or INDO) modulators, poliovirus receptor-related immunoglobulin domain-containing protein (PVRIG) modulators, lymphocyte-activation gene 3 (LAG3; also known as cluster of differentiation 223 or CD223) antagonists, cluster of differentiation 276 (CD276 or B7-H3) antigen modulators, cluster of differentiation 47 (CD47) antagonists, cluster of differentiation 30 (CD30) modulators, cluster of differentiation 73 (CD73) modulators, cluster of differentiation 66 (CD66) modulators, cluster of differentiation w137 (CDw137) agonists, cluster of differentiation 158 (CD158) modulators, cluster of differentiation 27 (CD27) modulators, cluster of differentiation 58 (CD58) modulators, cluster of differentiation 80 (CD80) modulators, cluster of differentiation 33 (CD33) modulators, cluster of differentiation 159 (CD159 or NKG2) modulators, glucocorticoid-induced TNFR-related (GITR) protein modulators, Killer Ig-like receptor (KIR) modulators, growth arrest-specific protein 6 (GAS6)/AXL pathway modulators, A proliferation-inducing ligand (APRIL) receptor modulators, human leukocyte antigen (HLA) modulators, epidermal growth factor receptor (EGFR) modulators, B-lymphocyte cell adhesion molecule modulators, cluster of differentiation w123 (CDw123) modulators, Erbb2 tyrosine kinase receptor modulators, endoglin modulators, mucin modulators, mesothelin modulators, hepatitis A virus cellular receptor 2 (HAVCR2) antagonists, cancer-testis antigen (CTA) modulators, tumor necrosis factor receptor superfamily, member 4 (TNFRSF4 or OX40 ) modulators, adenosine receptor modulators, inducible T cell co-stimulator (ICOS) modulators, cluster of differentiation 40 (CD40) modulators, tumor-infiltrating lymphocytes (TIL) therapies, or T-cell receptor (TCR) therapies.

Exemplary drugs that could be included in the delivery devices described herein include, but are not limited to: etanercept, abatacept, adalimumab, evolocumab, exenatide, secukinumab, erenumab, galcanezumab, fremanezumab-vfrm, alirocumab, methotrexate (amethopterin), tocilizumab, interferon beta-1a, interferon beta-1b, peginterferon beta-1a, sumatriptan, darbepoetin alfa, belimumab, sarilumab, semaglutide, dupilumab, reslizumab, omalizumab, glucagon, epinephrine, naloxone, insulin, amylin, vedolizumab, eculizumab, ravulizumab, crizanlizumab-tmca, certolizumab pegol, satralizumab, denosumab, romosozumab, benralizumab, emicizumab, tildrakizumab, ocrelizumab, ofatumumab, natalizumab, mepolizumab, risankizumab-rzaa, ixekizumab, and immune globulins.

Exemplary drugs that could be included in the delivery devices described herein may also include, but are not limited to, oncology treatments such as ipilimumab, nivolumab, pembrolizumab, atezolizumab, durvalumab, avelumab, cemiplimab, rituximab, trastuzumab, ado-trastuzumab emtansine, fam-trastuzumab deruxtecan-nxki, pertuzumab, transtuzumab-pertuzumab, alemtuzumab, belantamab mafodotin-blmf, bevacizumab, blinatumomab, brentuximab vedotin, cetuximab, daratumumab, elotuzumab, gemtuzumab ozogamicin, 90-Yttrium-ibritumomab tiuxetan, isatuximab, mogamulizumab, moxetumomab pasudotox, obinutuzumab, ofatumumab, olaratumab, panitumumab, polatuzumab vedotin, ramucirumab, sacituzumab govitecan, tafasitamab, or margetuximab.

Exemplary drugs that could be included in the delivery devices described herein include “generic” or biosimilar equivalents of any of the foregoing, and the foregoing molecular names should not be construed as limiting to the “innovator” or “branded” version of each, as in the non-limiting example of innovator medicament adalimumab and biosimilars such as adalimumab-afzb, adalimumab-atto, adalimumab-adbm, and adalimumab-adaz.

Exemplary drugs that could be included in the delivery devices described herein also include, but are not limited to, those used for adjuvant or neoadjuvant chemotherapy, such as an alkylating agent, plant alkaloid, antitumor antibiotic, antimetabolite, or topoisomerase inhibitor, enzyme, retinoid, or corticosteroid. Exemplary chemotherapy drugs include, by way of example but not limitation, 5-fluorouracil, cisplatin, carboplatin, oxaliplatin, doxorubicin, daunorubicin, idarubicin, epirubicin, paclitaxel, docetaxel, cyclophosphamide, ifosfamide, azacitidine, decitabine, bendamustine, bleomycin, bortezomib, busulfan, cabazitaxel, carmustine, cladribine, cytarabine, dacarbazine, etoposide, fludarabine, gemcitabine, irinotecan, leucovorin, melphalan, methotrexate, pemetrexed, mitomycin, mitoxantrone, temsirolimus, topotecan, valrubicin, vincristine, vinblastine, or vinorelbine.

Exemplary drugs that could be included in the delivery devices described herein also include, but are not limited to, analgesics (e.g., acetaminophen), antipyretics, corticosteroids (e.g. hydrocortisone, dexamethasone, or methylprednisolone), antihistamines (e.g., diphenhydramine or famotidine), antiemetics (e.g., ondansetron), antibiotics, antiseptics, anticoagulants, fibrinolytics (e.g., recombinant tissue plasminogen activator [r-TPA]), antithrombolytics, or diluents such as sterile water for injection (SWFI), 0.9% Normal Saline, 0.45% normal saline, 5% dextrose in water, 5% dextrose in 0.45% normal saline, Lactated Ringer's solution, Heparin Lock Flush solution, 100 U/mL Heparin Lock Flush Solution, or 5000 U/mL Heparin Lock Flush Solution.

Pharmaceutical formulations including, but not limited to, any drug described herein are also contemplated for use in the delivery devices described herein, for example pharmaceutical formulations comprising a drug as listed herein (or a pharmaceutically acceptable salt of the drug) and a pharmaceutically acceptable carrier. Such formulations may include one or more other active ingredients (e.g., as a combination of one or more active drugs), or may be the only active ingredient present, and may also include separately administered or co-formulated dispersion enhancers (e.g. an animal-derived, human-derived, or recombinant hyaluronidase enzyme), concentration modifiers or enhancers, stabilizers, buffers, or other excipients.

Exemplary drugs that could be included in the delivery devices described herein include, but are not limited to, a multi-medication treatment regimen such as AC, Dose-Dense AC, TCH, GT, EC, TAC, TC, TCHP, CMF, FOLFOX, mFOLFOX6, mFOLFOX7, FOLFCIS, CapeOx, FLOT, DCF, FOLFIRI, FOLFIRINOX, FOLFOXIRI, IROX, CHOP, R-CHOP, RCHOP-21, Mini-CHOP, Maxi-CHOP, VR-CAP, Dose-Dense CHOP, EPOCH, Dose-Adjusted EPOCH, R-EPOCH, CODOX-M, IVAC, HyperCVAD, R-HyperCVAD, SC-EPOCH-RR, DHAP, ESHAP, GDP, ICE, MINE, CEPP, CDOP, GemOx, CEOP, CEPP, CHOEP, CHP, GCVP, DHAX, CALGB 8811, HIDAC, MOPAD, 7+3, 5+2, 7+4, MEC, CVP, RBAC 500, DHA-Cis, DHA-Ca, DHA-Ox, RCVP, RCEPP, RCEOP, CMV, DDMVAC, GemFLP, ITP, VIDE, VDC, VAI, VDC-IE, MAP, PCV, FCR, FR, PCR, HDMP, OFAR, EMA/CO, EMA/EP, EP/EMA, TP/TE, BEP, TIP, VIP, TPEx, ABVD, BEACOPP, AVD, Mini-BEAM, IGEV, C-MOPP, GCD, GEMOX, CAV, DT-PACE, VTD-PACE, DCEP, ATG, VAC, VeIP, OFF, GTX, CAV, AD, MAID, AIM, VAC-IE, ADOC, or PE.

Various modifications to the embodiments described are possible and will occur to those skilled in the art without departing from the invention which is defined by the following claims.

1-13. (canceled)

14. A bag assembly for a medicament delivery device, the bag assembly comprising:
a medicament bag configured to receive a fluid medicament;
a port in fluid connection with an interior of the medicament bag and configured to allow the fluid medicament to enter and exit the medicament bag; and
a frame surrounding the medicament bag,
wherein the frame is at least in partial connection with the medicament bag and configured to support the medicament bag in a first axis direction and/or second axis direction, and
wherein the medicament bag comprises at least one fastening member and the frame comprises at least one corresponding receiving member configured to engage with the fastening member.

15. The bag assembly according to claim 14, wherein the frame is at least in partial connection with the medicament bag at an outer circumference of the medicament bag in the first and/or second axis direction.

16. The bag assembly according to claim 14, wherein the fastening member is a form fit feature provided at an outer circumference of the medicament bag.

17. The bag assembly according to claim 16, wherein the form fit feature is a slit or a hole.

18. The bag assembly according to claim 14, wherein the receiving member is a knob-shaped member, a hook, or a pin.

19. The bag assembly according to claim 14, wherein frame comprises a first frame part and a second frame part, and wherein the receiving member is formed as complementary shapes on the first frame part and the second frame part.

20. The bag assembly according to claim 14, wherein the receiving member protrudes from the frame in a direction perpendicular to the first axis direction and the second axis direction.

21. The bag assembly according to claim 14, wherein the frame is connected to the port.

22. The bag assembly according to claim 14, wherein the frame is integrally formed with the port.

23. The bag assembly according to claim 14, wherein a film is configured to enclose the medicament bag and a least a portion of the port.

24. The bag assembly according to claim 23, wherein the film is closed by welding, in particular ultrasonic welding, or gluing.

25. The bag assembly according to claim 23, wherein the film is attached to both sides of the frame.

26. The bag assembly according to claim 23, wherein the at least one fastening member is provided in a welding seam of the film and/or the medicament bag.

27. The bag assembly according to claim 14, wherein the first axis direction is a lateral direction and the second axis direction is a longitudinal direction.
